(19) United States
(12) Patent Application Publication
(10) Pub. No.: US 2003/0117926 A1
(43) Pub. Date: Jun. 26, 2003

(54) Address decoder

(76) Inventors: Yoshihiro Hori, Gifu (JP); Toshitaka Kuma, Moriguchi-shi (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/297,931

(22) PCT Filed: Sep. 4, 2001
(86) PCT No.: PCT/JP01/07662

(30) Foreign Application Priority Data
Oct. 2, 2000 (JP) 2000-302484

(51) Int. Cl. G11B 7/005

(52) U.S. Cl. 369/59.23; 369/47.22

(57) ABSTRACT

An address decoder includes a PLL circuit generating a PLL clock signal synchronized with an external clock signal, a frequency divider dividing the PLL clock signal, a selector selecting a binary wobble signal or an inverted signal thereof, a timing generator generating each of sync window signals, a biphase enable signal, CRC enable signals, a CRC polarity signal, and an output enable signal, a biphase decoder decoding a wobble signal selected by the selector, a Gray code decoder decoding a biphase decode data, and an output control circuit outputting a decoded address signal. Therefore, this address decoder can reproduce an address signal by decoding the wobble signal.

### TECHNICAL FIELD

The present invention relates to an address decoder and, more particularly, to an address decoder reproducing an address preformatted by forming a wobble on a groove of an optical disk.

### BACKGROUND ART

In a magneto-optical disk, a method of recording an address by forming a wobble on a side wall of a groove is widely used. Particularly in a minidisk, a method is used wherein an address is recorded by forming wobbles on both side walls of a groove based on a signal obtained by a biphase conversion (encoding) and a frequency modulation (FM) of the address.

On the other hand, Japanese Patent Laying-Open No. 11-45441 proposed a method of recording an address by forming wobble(s) on one or both side wall(s) of a groove based on a signal obtained by a Gray code conversion (encoding) and a biphase conversion (encoding) of the address, in order to enhance a record density and an efficiency of a laser power.

FIG. 12 is a plan view showing wobble shapes around address regions recorded by the method as mentioned above. For convenience, the address shown herein includes a detection pattern of 4 bits long, an address value of 8 bits long, and an error-correction code of 4 bits long. In addition, each address is converted to a Gray code signal, and then converted to a biphase signal.

Addresses “17”, “18” and “19” are recorded in grooves G17, G18 and G19, respectively. Addresses “17” and “18” are recorded in lands L17 and L18, respectively. As wobbles are formed on the groove, shapes of both side walls of the groove are the same. In an address region AF1, though shapes of both side walls of land L17 are different, shapes of both side walls of land L18 are the same. In an address region AF2, though shapes of both side walls of land L17 are the same, shapes of both side walls of land L18 are different.

Thus, in the groove, the address can be obtained by alternately selecting the address of address region AFI and the address of address region AF2 for each track. On the other hand, in the land, the address can be obtained only by address region AF1 or AF2 wherein the wobble shapes of both side walls are the same. The address cannot be reproduced from address region AF1 of land L17, because the side walls thereof, that is, one side wall of groove G17 and the opposed one side wall of groove G18, have different wobble shapes. The address, however, can be reproduced from address region AF2 of land L17, because the side walls thereof, that is, one side wall of groove G17 and the opposed one side wall of groove G18, have the same wobble shape. Similarly, in land L18, the address can be obtained only from address region AF1 wherein both side walls have the same wobble shape.

To reproduce the address from the wobble shape as shown in FIG. 12, a laser beam emitted from a laser source of an optical pickup enters an objective lens through a beam splitter, condenses on a disk and forms a beam spot. Reflected light from the beam spot is received by a sensor, and converted to an electric signal.

FIG. 13 shows a sensor shape, a wavelength λ of a laser, and an operation method of a focus error signal FE, a tracking error signal TE, a reproduction signal RF, a magneto-optic signal MO, a wobble signal ADR, and an external clock signal CLK in a magneto-optical disk such as an ASMO (Advanced Storage Magneto-Optical disk), a phase change disk such as a DVD (Digital Video Disk), and an optical disk such as a CD (Compact Disk). Each sensor is formed with a main deflector 401 and a sub deflector 400. Main deflector 401 of the AS-MO is a four-part split photodetector, and the address signal is obtained by the wobble signal ADR (=(A+B)−(C+D)).

FIG. 14 is a circuit diagram showing a wobble detector to obtain a wobble signal ADRT, a binary signal of the wobble signal ADR, from a reflected light received by main deflector 401. Main deflector 401 converts the received reflected light to an electric signal, and outputs a signal A+B and a signal C+D to a differential amplifier 402. The output (A+B)−(C+D) of differential amplifier 402 goes through a band-pass filter (BPF) 403, and is input to a comparator 404 as the wobble signal ADR. Comparator 404 binarizes the wobble signal ADR and outputs the wobble signal ADRT (binary signal).

Though a magneto-optical disk recording/reproduction apparatus to record and reproduce signals on the magneto-optical disk as described above needs an address decoder to decode the above-mentioned wobble signal to the address signal, the specific circuit structure thereof has not been proposed yet.

### DISCLOSURE OF THE INVENTION

An object of the present invention is to provide an address decoder to reproduce an address signal by decoding a wobble signal.

According to the present invention, an address decoder to reproduce an address signal based on a wobble signal detected from an optical disk which has a land and a groove and has an address preformatted therein by forming a wobble on the groove includes biphase decoding means and Gray code decoding means. The biphase decoding means decodes the wobble signal. The Gray code decoding means decodes a signal output from the biphase decoding means.

Preferably, the address decoder further includes PLL means, frequency division means, timing generation means, and output control means. The PLL means divides an external clock signal and synchronizes it with the wobble signal to output a PLL clock signal. The frequency division means divides the PLL clock signal to output a divided clock signal. The timing generation means generates a biphase enable signal, a Gray code enable signal, and an output enable signal. The biphase decoding means is activated in response to the divided clock signal and the biphase enable signal, and operates in synchronization with the PLL clock signal. The Gray code decoding means is activated in response to the divided clock signal and the Gray code enable signal, and operates in synchronization with the PLL clock signal. The output control means is activated in response to the output enable signal, and outputs the signal output from the Gray code decoding means as the address signal.

Thus, the address decoder can decode the wobble signal detected from the optical disk to the address signal.

It is preferable that, at least two addresses are continuously preformatted in the optical disk.

It is further preferable that, the address decoder further includes inverting means and selecting means. The inverting means inverts the wobble signal. The selecting means selects one of the wobble signal and the wobble signal inverted by the inverting means in response to a land/groove signal indicating whether the track being accessed at present is a land or a groove.

Therefore, this address decoder can reproduce the address signal both in the land and the groove.

It is further preferred that, a predetermined fixed pattern is preformatted prior to at least two addresses in the optical disk. The address decoder further includes sync pattern detection means. The sync pattern detection means detects the fixed pattern and outputs a sync detection signal. The frequency division means is reset in response to the sync detection signal.

Preferably, the address decoder further includes error detection means. The error detection means detects an error of the signal output from the biphase decoding means or the Gray code decoding means.

### BRIEF DESCRIPTION OF THE DRAWINGS

FIG. 1 shows wobble shapes of an address region in an AS-MO format.

FIG. 2 is a circuit diagram showing a structure of an address decoder in an embodiment of the present invention.

FIG. 3 is a circuit diagram showing a structure of a PLL circuit shown in FIG. 2.

FIG. 4 is a timing chart showing an operation of the PLL circuit shown in FIG. 3.

FIG. 5 is a circuit diagram showing a structure of a sync pattern detector shown in FIG. 2.

FIG. 6 is a circuit diagram showing a structure of a biphase decoder shown in FIG. 2.

FIG. 7 is a circuit diagram showing a structure of a Gray code decoder shown in FIG. 2.

FIG. 8 is a circuit diagram showing a structure of a first CRC circuit shown in FIG. 2.

FIG. 9 is a timing chart showing an operation of the address decoder shown in FIG. 2, when an address signal is reproduced from a groove.

FIG. 10 is a timing chart showing an operation of the address decoder shown in FIG. 2, when the address signal is reproduced from a land.

FIG. 11 is a timing chart showing an operation of the address decoder shown in FIG. 2, when a biphase error occurs.

FIG. 12 is a plan view showing wobble shapes around address regions disclosed in Japanese Patent Laying-Open No. 11-45441.

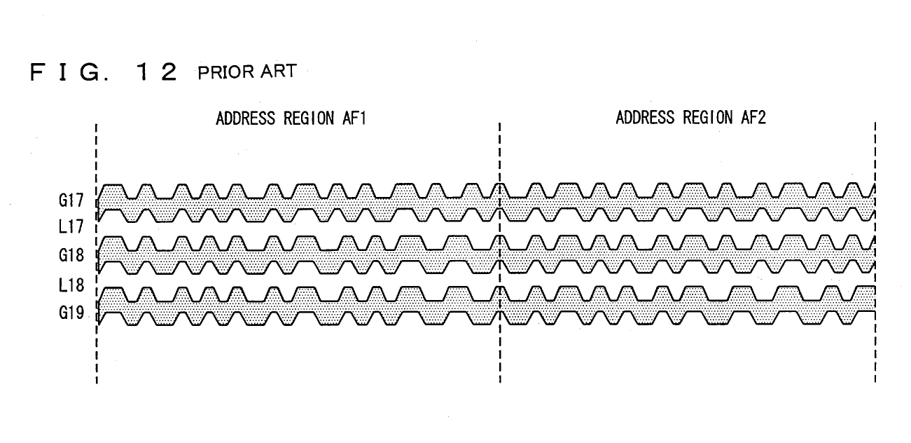

FIG. 13 shows a sensor shape, a wavelength of a laser, an operation method of a focus error signal, a tracking error signal, a reproduction signal, a magneto-optic signal, a wobble signal, and an external clock signal in an AS-MO, a DVD, and a CD.

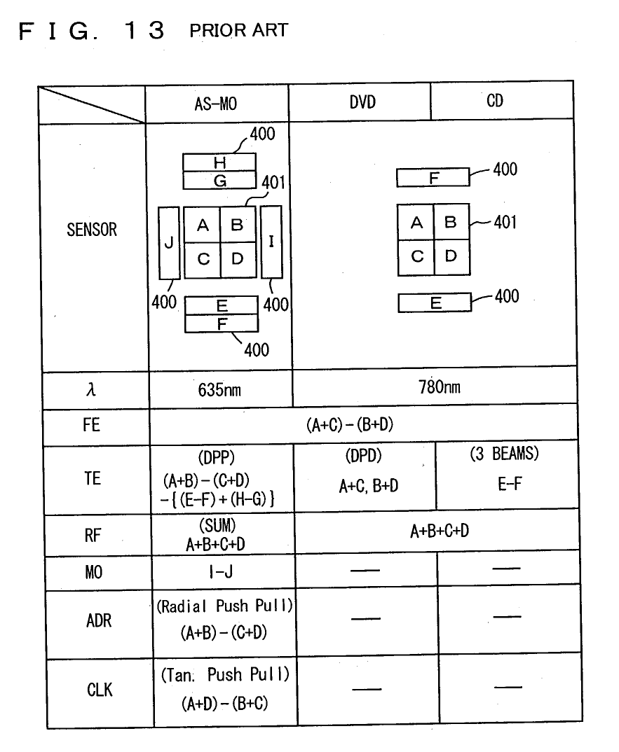

FIG. 14 is a circuit diagram showing a wobble detector to detect the wobble signal from the AS-MO.

### BEST MODE FOR CARRYING OUT THE INVENTION

Embodiments of the present invention will now be described in detail with reference to the drawings. The same characters in the drawings indicate the same or corresponding portions, and the description thereof will not be repeated.

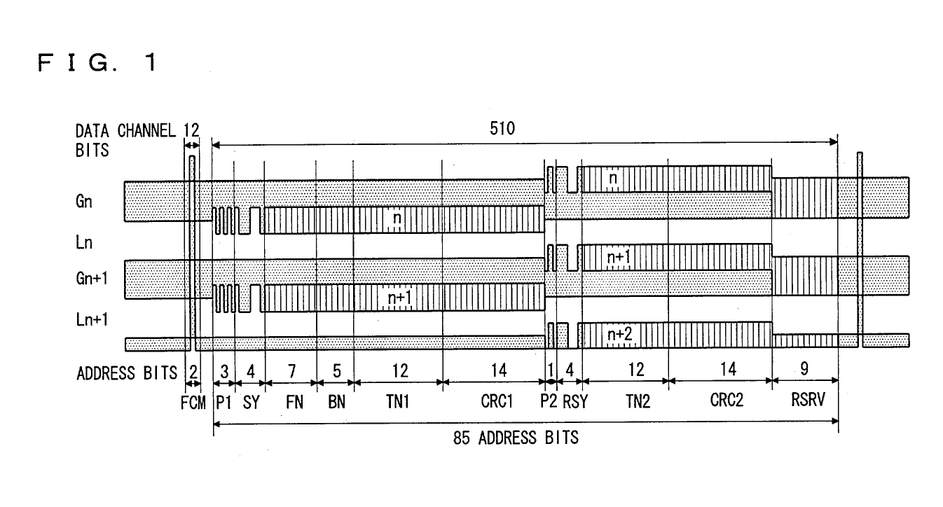

FIG. 1 shows wobble shapes in an address region in an AS-MO (ASMO Format ver. 1.0). Herein, a wobble is formed only on one side wall of a groove.

An address bit (ADB) includes six data channel bits (DCBs). Address information is converted to a biphase signal which rises when a bit value is 0, and falls when a bit value is 1. More specifically, 0 is converted to (10) pattern, while 1 is converted to (01) pattern. The wobble is formed in the address region of 85 ADBs, following a fine clock mark FCM of 2 ADBs.

The address region is formed with a first preamble region P1, a synchronization region SY, a frame number region FN, a band number region BN, a first track number region TN1, a first CRC (Cyclic Redundancy Check) region CRC1, a second preamble region P2, a resynchronization region RSY, a second track number region TN2, a second CRC region CRC2, and a reserve region RSRV.

A fixed pattern (101010) of 3 ADBs is preformatted in the first preamble region P1. A fixed pattern (10001110) of 4 ADBs, which does not appear in a biphase conversion for synchronizing the address data, is preformatted in synchronization region SY. A frame address of 7 ADBs is preformatted in frame number region FN. A band address of 5 ADBs is preformatted in band number region BN. A first track address of 12 ADBs is preformatted in the first track number region TN1. A data of 14 ADBs for correcting errors of a frame number, a band number, and a first track number is preformatted in the first CRC region CRC1. A fixed pattern (01) of 1 ADB is preformatted in the second preamble region P2. A fixed pattern (01110001) of 4 ADBs, which does not appear in the biphase conversion for resynchronizing the address data, is preformatted in resynchronization region SY. A second track address of 12 ADBs is preformatted in the second track number region TN2. A data of 14 ADBs for correcting errors of the frame number, the band number, and the second track number is preformatted in the second CRC region CRC2. A data of 9 ADBs for a tilt mark or the like is preformatted in the reserve region RSRV.

A check polynomial P(X) used in the first and second CRC regions CRC1 and CRC2 is represented as follows.

P(X)=X¹⁴+X¹²+X¹⁰+X⁷+X⁴+X²1

Binary information (24 bits) of the address information (the band number, track number and frame number) is represented as a polynomial of X of order 23. This polynomial is. divided by the check polynomial P(X) of order 14, and a coefficient of the residual polynomial of X of order 13 is recorded in a wobble shape in a groove of a disk with the address information as the CRC of this address information. Therefore, when the address information is reproduced, the reproduced address information and the CRC are divided by the check polynomial P(X) to detect the address error by whether they are divisible or not.

In the AS-MO format shown in FIG. 1, for example, the same address n is reproduced twice in a groove Gn, while two addresses n and n+1 are reproduced in a land Ln. Therefore, in the land, one of the two reproduced addresses must be selected.

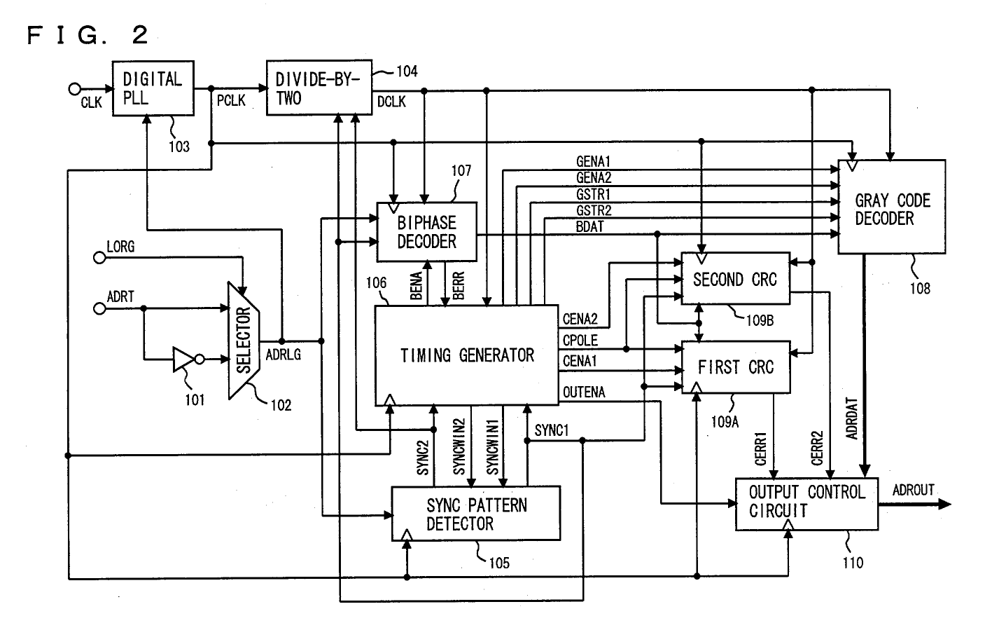

FIG. 2 is a circuit diagram showing a structure of an address decoder in the embodiment of the present invention. This address decoder is provided to decode the wobble signal obtained from the address region in the AS-MO format shown in FIG. 1 to the address signal.

Referring to FIG. 2, the address decoder includes an inverter 101, a selector 102, a digital PLL circuit 103, a divide-by-two frequency divider 104, a sync pattern detector 105, a timing generator 106, a biphase decoder 107, a Gray code decoder 108, a first CRC circuit 109A, and a second CRC circuit 109B.

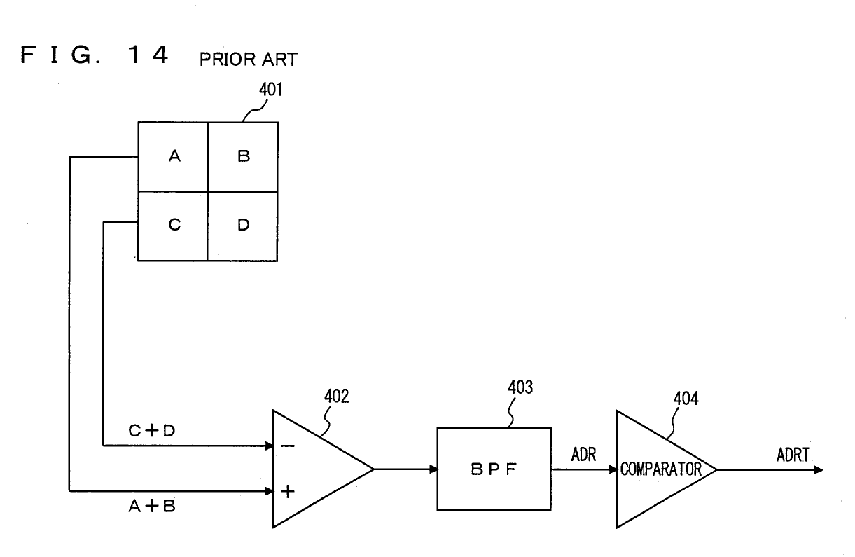

Inverter 101 inverts the binary wobble signal ADRT output from the wobble detector shown in FIG. 14, and feeds the result to selector 102. Selector 102 responds to a land/groove signal LORG indicating whether the track being accessed at present is a land or a groove, and selects the wobble signal ADRT or the inverted signal thereof, and feeds the result as a signal ADRLG to digital PLL circuit 103, sync pattern detector 105, and biphase decoder 107. It is to be noted that, though the land/groove signal is. generated in a known manner by detecting the fine clock mark FCM, it can be switched corresponding to an access indication from a microcomputer or the like, when it is known whether to access to the land or the groove corresponding to the indication.

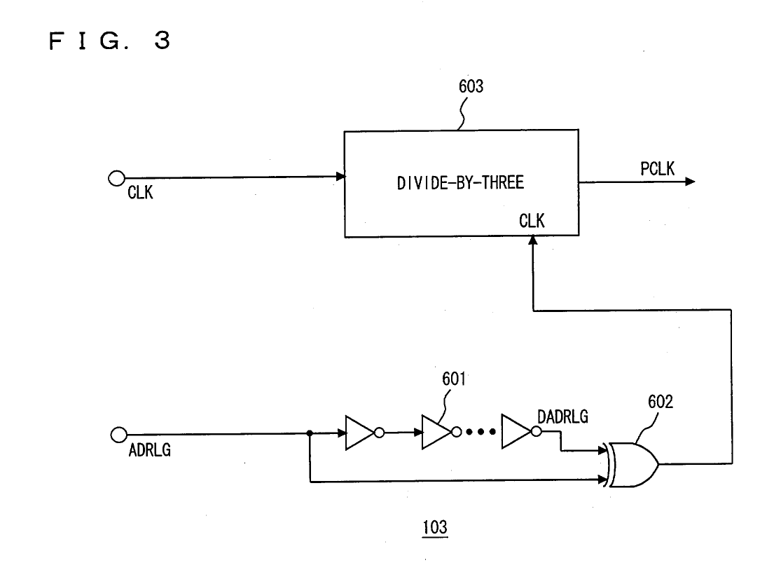

PLL circuit 103 outputs a PLL clock signal PCLK based on the external clock signal CLK input from the outside. FIG. 3 is a circuit diagram showing a structure of digital PLL circuit 103. Referring to FIG. 3, PLL circuit 103 includes a delay element 601 implemented by, for example, inverters of an even number, an exclusive OR gate 602, and a divide-by-three frequency divider 603. Delay element 601 and exclusive OR gate 602 form an one-shot circuit, which generates a clear signal CLR to reset divide-by-three frequency divider 603 in response to the signal ADRLG output from selector 102. Divide-by-three frequency divider 603 generates the PLL clock signal by dividing the external clock signal CLK by three.

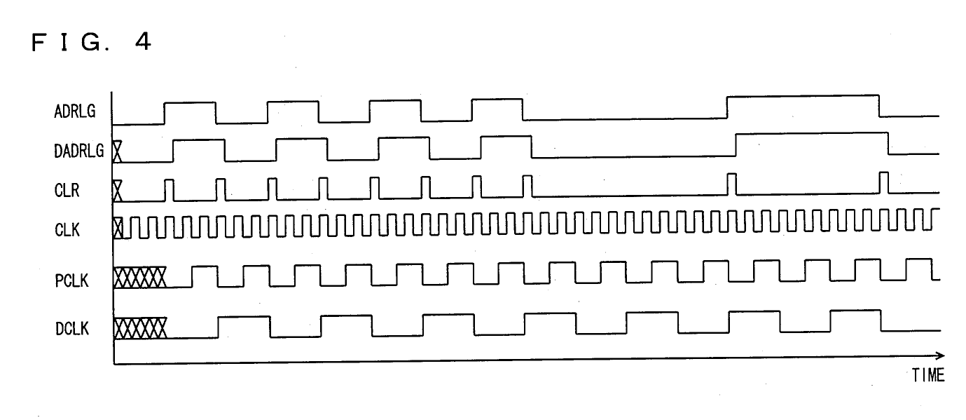

FIG. 4 is a timing chart showing an operation of PLL circuit 103 shown in FIG. 3. Referring to FIG. 4, the signal ADRLG is delayed by delay element 601, and thereby a delay signal DADRLG is generated. Responding to the signals ADRLG and DADRLG, the clear signal CLR is generated by exclusive OR gate 602, and then frequency divider 603 is cleared in response to the clear signal CLR. The external clock signal CLK is divided by three by frequency divider 603, and the PLL clock signal PCLK is generated. The division rate of frequency divider 603 is determined so as to generate a divide-by-three clock signal of the data channel clock signal from the external clock signal CLK, and herein it is set to three. Thus, PLL circuit 103 herein generates the PLL clock signal PLCK of 20 MHz based on the external clock signal CLK of 60 MHz.

Referring back to FIG. 2, digital PLL circuit 103 feeds the generated PLL clock signal PCLK to divide-by-two frequency divider 104, sync pattern detector 105, timing generator 106, biphase decoder 107, Gray code decoder 108, the first CRC circuit 109A, the second CRC circuit 109B, and output control circuit 110.

Divide-by-two frequency divider 104 divides the PLL clock signal PCLK by two, and feeds the result as the divided clock signal DCLK to timing generator 106, biphase decoder 107, Gray code decoder 108, the first CRC circuit 109A, and the second CRC circuit 109B. Therefore, divide-by-two frequency divider 104 generates the divided clock signal DCLK of 10 MHz based on the PLL clock signal of 20 MHz.

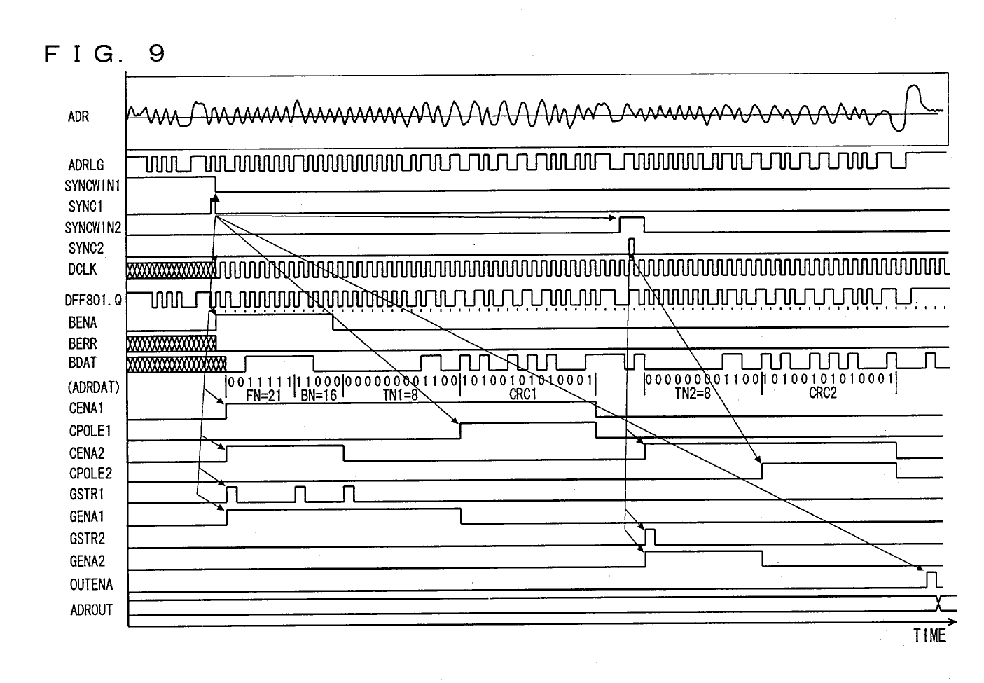

Timing generator 106 generates a biphase enable signal BENA, sync window signals SYNCWIN1 and SYNCWIN2, Gray code enable signals GENA1 and GENA2, Gray code reset signals GSTR1 and GSTR2, CRC enable signals CENA1 and CENA2, an output enable signal OUTENA, and CRC polarity signals CPOLE1 and CPOLE2, based on sync detection signals SYNC1 and SYNC2 from sync pattern detector 105, and a biphase error signal BERR from biphase decoder 107. Timing generator 106 generates these signals in synchronization with the PLL clock signal PCLK in a predetermined timing. Details of the timing will be described below with reference to FIGS. 9-11.

Based on the sync window signal SYNCWIN1 from timing generator 106, sync pattern detector 105 detects the fixed pattern (10001110) of the synchronization region SY shown in FIG. 1 from the signal ADRLG output from selector 102, and feeds the sync detection signal SYNC 1 representing the presence or absence of the detection to timing generator 106, divide-by-two frequency divider 104, biphase decoder 107, the first CRC circuit 109A, and the second CRC circuit 109B. Based on the sync window signal SYNCWIN2 from timing generator 106, sync pattern detector 105 also detects the fixed pattern (01110001) of the resynchronization region RSY shown in FIG. 1 from the signal ADRLG output from selector 102, and feeds the sync detection signal SYNC2 representing the presence or absence of the detection to timing generator 106 and divide-by-two frequency divider 104.

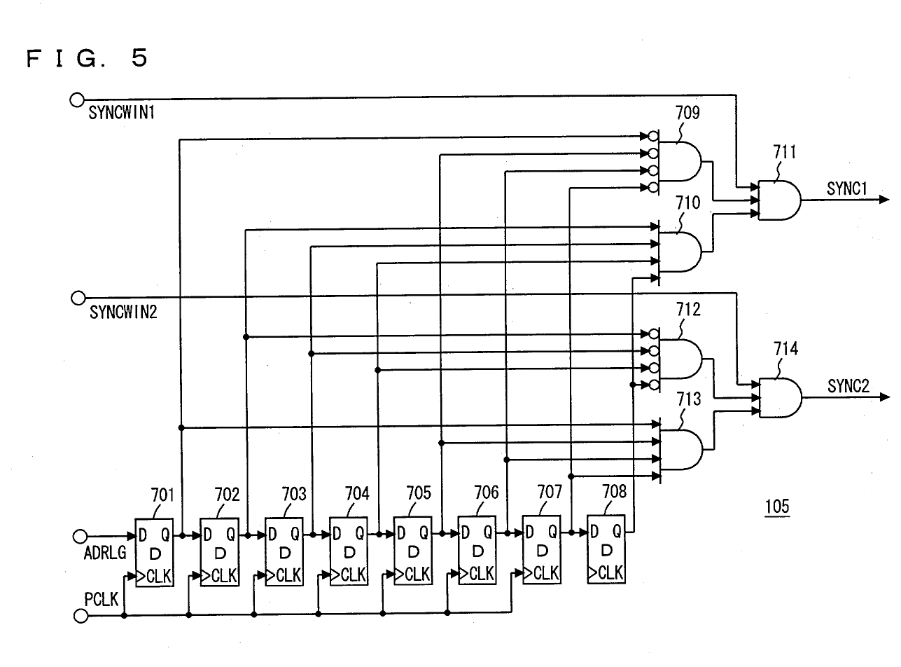

FIG. 5 is a circuit diagram showing a structure of sync pattern detector 105. Referring to FIG. 5, sync pattern detector 105 includes D flip-flops 701-708, NOR (negative logic) gates 709 and 712, and AND gates 710, 711, 713 and 714. D flip-flops 701-708 form a shift register, and successively receive the signal ADRLG output from selector 102 in synchronization with the PLL clock signal PCLK. NOR gate 709 and AND gate 710 detect the fixed pattern (10001110) in the synchronization region SY based on each output signal from D flip-flops 701-703. AND gate 711 outputs the sync detection signal SYNC 1 of the H (logical high) level if the fixed pattern (10001110) is detected when the sync window signal SYNCWIN1 is at the H level (1). NOR gate 712 and AND gate 713 detect the fixed pattern (01110001) in the resynchronization region RSY based on each output signal of D flip-flops 701-708. AND gate 714 outputs the sync detection signal SYNC2 of the H level if the fixed pattern (01110001) is detected when the sync window signal SYNCWIN2 is at the H level.

Referring back to FIG. 2, biphase decoder 107 is activated in response to the biphase enable signal BENA from timing generator 106, decodes the signal ADRLG output from selector 102, and feeds a decoded biphase decode data BDAT to Gray code decoder 108, the first CRC circuit 109A and the second CRC circuit 109B. Biphase decoder 107 also feeds the biphase error signal BERR representing the presence or absence of the biphase error to timing generator 106.

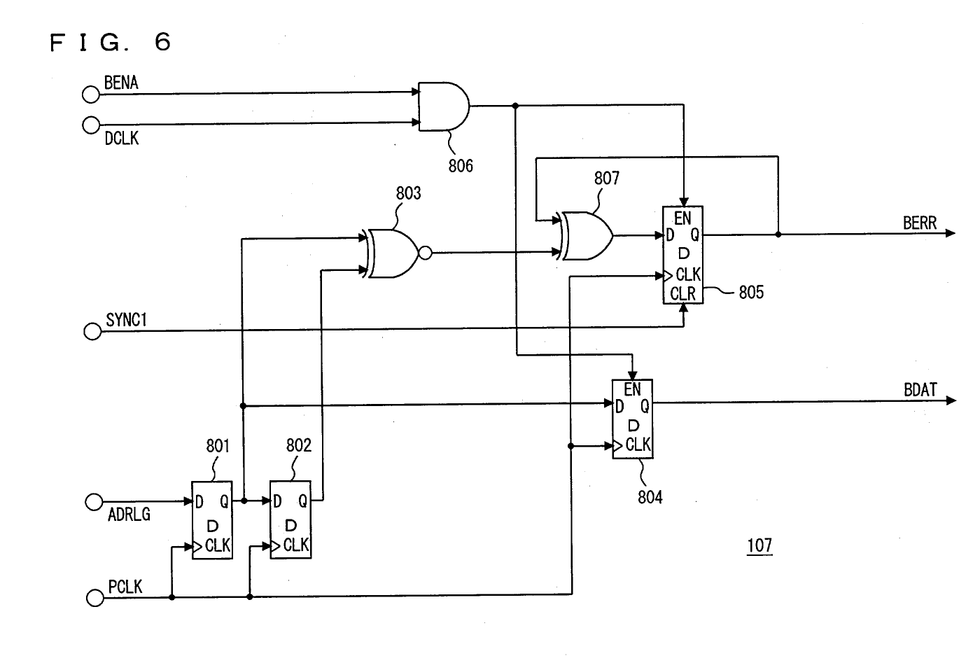

FIG. 6 is a circuit diagram showing a structure of biphase decoder 107. Referring to FIG. 6, this biphase decoder 107 includes D flip-flops 801, 802, 804 and 805, an AND gate 806, an exclusive NOR gate 803, and an exclusive OR gate 807. D flip-flops 801 and 802 form a shift register of 2 bits, and successively receive the signal ADRLG output from selector 102 in synchronization with the PLL clock signal PCLK. D flip-flop 804 is activated in response to the output signal of AND circuit 806, latches the output signal of D flip-flop 801 in response to the PLL clock signal PCLK, and outputs the same as the biphase decode data BDAT. D flip-flop 805 is activated in response to the output signal of AND gate 806 and is cleared in response to the sync detection signal SYNC1, latches the output signal of exclusive OR gate 807 in response to the PLL clock signal PCLK, and outputs the same as the biphase error signal BERR. As the biphase encoding converts a signal (0) to a signal (10) and a signal (1) to a signal (01), signals (00) and (11) cannot exist in the encoded signal ADRLG. Therefore, exclusive NOR gate 803 outputs a signal of the H level when the output signals of D flip-flops 801 and 802 are (00) or (11), and in response to this, D flip-flop 805 outputs the biphase error signal BERR of the H level.

Referring back to FIG. 2, Gray code decoder 108 is activated in response to the Gray code enable signals GENA1 and GENA2 from timing generator 106, decodes the biphase decode data BDAT output from biphase decoder 107, and feeds the result as the address data ADRDAT to output control circuit 110.

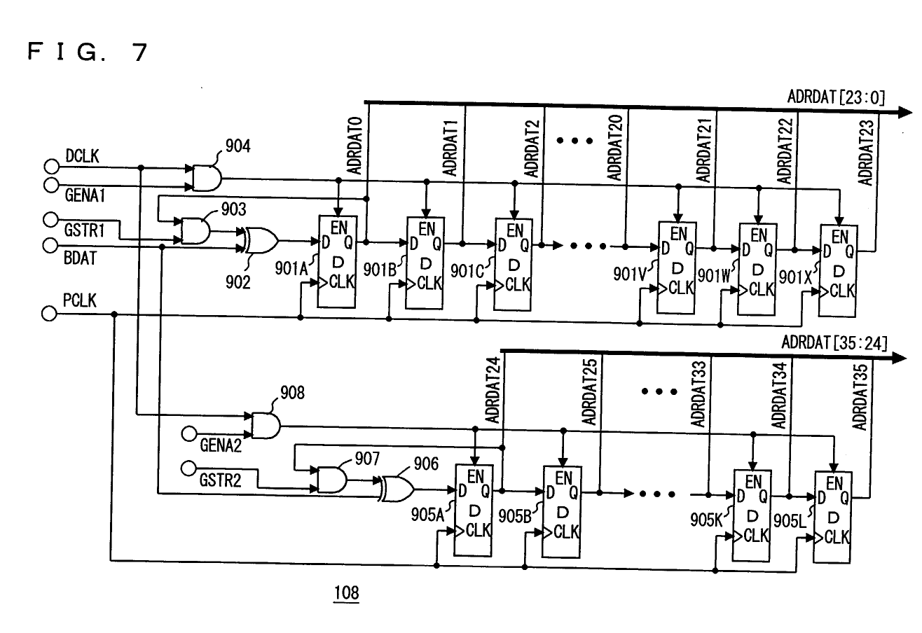

FIG. 7 is a circuit diagram showing a structure of Gray code decoder 108. Referring to FIG. 7, Gray code decoder 108 includes twenty-four D flip-flops 901A-901X, an exclusive OR gate 902, AND gates 903 and 904, twelve D flip-flops 904A-905L, an exclusive OR gate 906, and AND gates 907 and 908. D flip-flops 901A-901X form a shift register, respond to the PLL clock signal PCLK and successively receive the output signal from exclusive OR gate 902. The divided signal DCLK and the Gray code enable signal GENA1 are input to AND gate 904, and the output signal of AND gate 904 is fed as an enable signal to D flip-flops 901A-901X. Therefore, the shift register formed with D flip-flops 901A-901X is activated in response to the output signal of AND gate 904. The Gray code reset signal GSTR1 and the output signal of D flip-flop 901A are input to AND gate 903, and the output signal thereof is input to exclusive OR gate 902. Therefore, D flip-flops 901A-901X, exclusive OR gate 902, and AND gate 903 decode the biphase decoder data BDAT output from biphase decoder 107, and output the address data ADRDAT [23:0] of 24 bits.

D flip-flops 905A-905L form a shift register, and successively receive the output signal of exclusive NOR gate 906 in response to the PLL clock signal PCLK. The divided clock signal DCLK and the Gray code enable signal GENA2 are input to AND gate 908, and the output signal thereof is input as an enable signal to D flip-flops 905A-905L. D flip-flops 905A-905L are enabled in response to the output signal of AND gate 908, and successively receive the output signal of exclusive OR gate 906 in response to the PLL clock signal PCLK. The Gray code reset signal GSTR2 and the output signal of D flip-flop 905A are input to AND gate 907, and the output signal thereof is input to exclusive NOR gate 906. The biphase decode data signal BDAT and the output signal of AND gate 907 are input to exclusive NOR gate 906, and the output signal thereof is input to D flip-flop 905A. The Gray code reset signal GSTR2 and the output signal of D flip-flop 905A are input to AND gate 907, and the output signal thereof is fed to exclusive OR gate 906. Therefore, D flip-flops 905A-905L forming the shift register, OR gate 906 and AND gate 907 output the address data ADRDAT [35:24] of 10 bits.

Herein, the address data ADRDAT [0:6] indicates the frame number, the address data [7:11] indicates the band number, the address data ADRDAT [12:23] indicates the first track number, and the address data [24:35] indicates the second track number.

Referring back to FIG. 2, the first CRC circuit 109A is activated in response to the CRC enable signal CENAL from timing generator 106, detects the error of the biphase decode data BDAT, and feeds the detection result as an error detection signal CERR1 to output control circuit 110. The second CRC circuit 109B is activated in response to the CRC enable signal CENA2, detects the error of the biphase decoder data BDAT, and feeds the detection result as an error detection signal CERR2 to output control circuit 110.

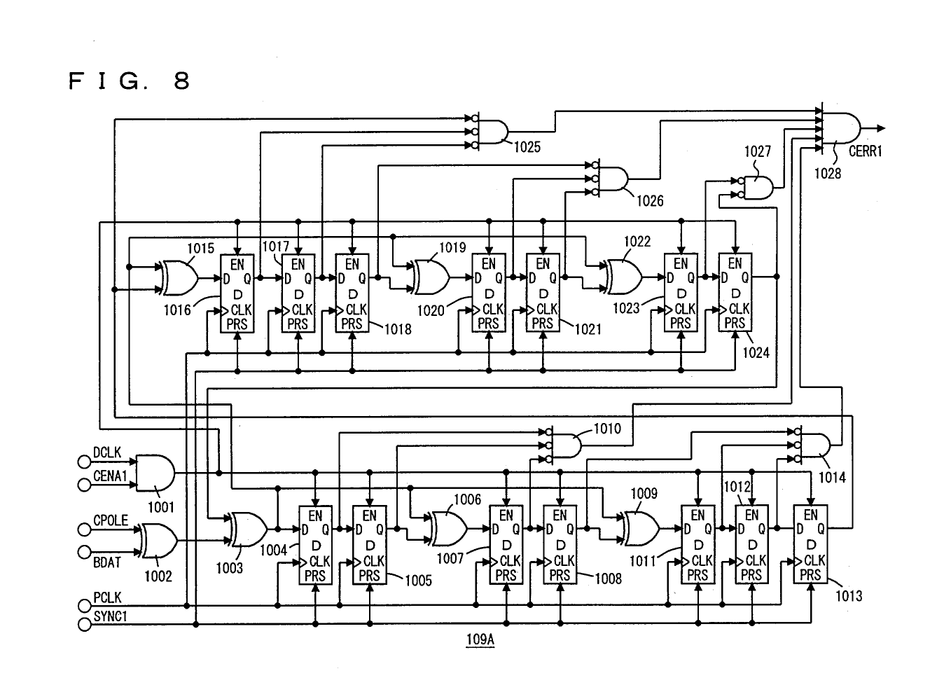

FIG. 8 is a circuit diagram showing a structure of the first CRC circuit 109A. Referring to FIG. 8, the first CRC circuit 109A includes an AND gate 1001, exclusive OR gates 1002 and 1003, D flip-flops 1004 and 1005, an exclusive OR gate 1006, D flip-flops 1007 and 1008, an exclusive OR gate 1009, an NOR (negative logic) gate 1010, D flip-flops 1011-1013, an NOR (negative logic) gate 1014, an exclusive OR gate 1015, D flip-flops 1016-1018, an exclusive OR gate 1019, D flip-flops 1020 and 1021, an exclusive OR gate 1022, D flip-flops 1023 and 1024, NOR gates 1025-1027, and an AND gate 1028. The second CRC circuit 109B has a similar structure.

The divided clock signal DCLK and the CRC enable signal CENA1 are input to AND gate 1001, and the output signal thereof is fed as an enable signal to D flip-flops 1004, 1005, 1007, 1008, and 1011-1013. The sync detection signal SYNC1 is fed as a clear signal to the D flip-flops 1004, 1005, 1007, 1008, and 1011-1013. The CRC polarity signal CPOLE 1 and the biphase decode data BDAT are input to exclusive OR gate 1002, and the output signal thereof is fed to exclusive OR gate 1003. The output signal of exclusive OR gate 1003 is fed to exclusive OR gates 1006, 1009, 1015, 1019, and 1022, in addition to D flip-flop 1004. D flip-flops 1004 and 1005 successively receive the output signal of exclusive OR gate 1003 in response to the PLL clock signal PCLK. The output signal of D flip-flop 1005 is fed to exclusive OR gate 1006. D flip-flops 1007 and 1008 successively receive the output signal of exclusive OR gate 1006 in response to the PLL clock signal PCLK. The output signal of D flip-flop 1008 is fed to exclusive OR gate 1009. D flip-flops 1011-1013 successively receive the output signal of exclusive OR gate 1009 in response to the PLL clock signal PCLK. The output signal of D flip-flop 1013 is fed to exclusive OR gate 1015. D flip-flops 1016-1018 successively receive the output signal of the exclusive OR gate in response to the PLL clock signal PCLK. The output signal of D flip-flop 1018 is fed to exclusive OR gate 1019. D flip-flops 1020 and 1021 successively receive the output signal of exclusive OR gate 1019 in response to the PLL clock signal PCLK. The output signal of D flip-flop 1021 is fed to exclusive OR gate 1022. D flip-flops 1023 and 1024 successively receive the output signal of exclusive OR gate 1022 in response to the PLL clock signal PCLK. Each of the output signals of D flip-flops 1004, 1005 and 1007 is fed to NOR gate 1010. Each of the output signals of D flip-flops 1008, 1011 and 1012 is fed to NOR gate 1014. Each of the output signals of D flip-flops 1013, 1016 and 1017 is fed to NOR gate 1025. Each of the output signals of D flip-flops 1018, 1020 and 1021 is fed to NOR gate 1026. Each of the output signals of D flip-flops 1023 and 1024 is fed to NOR gate 1027. Each of the output signals of NOR gates 1010, 1014 and 1025-1027 is fed to AND gate 1028, and thereby the CRC error signal CERR1 is output.

Though CRC circuits 109A and 109B herein detect the error of the signal output from biphase decoder 107, these can be made to detect the error of the signal output from Gray code decoder 108.

Operations of the above-mentioned address decoder will now be described.

FIG. 9 is a timing chart showing the operation of the address decoder when the address signal is reproduced from the groove. Referring to FIG. 9, the wobble signal ADR is binarized by comparator 404 shown in FIG. 14, and the binarized wobble signal ADRT is selected by selector 102 shown in FIG. 2 in response to the land/groove signal LORG indicating the groove, and is directly output as the signal ADRG.

If the fixed pattern (10001110) exists in the signal ADRLG while the sync window signal SYNCWIN1 is at the H level, the pattern is detected by sync pattern detector 105, and the sync detection signal SYNC1 is generated.

In response to the sync detection signal SYNC1, the sync window signal SYNCWIN1 is set to the L (logical low) level and the generation of the divided clock signal DCLK starts, and a biphase enable signal BENA1, the CRC enable signals CENA1 and CENA2, the Gray code reset signal GSTR1, and the Gray code enable signal GENA1 are set to the H level.

D flip-flop 801 in biphase decoder 107 as shown in FIG. 6 latches the signal ADRLG output from selector 102 in response to the PLL clock signal PCLK, and outputs the latched signal DFF801.Q. While the biphase enable signal BENA is at the H level, biphase decoder 107 decodes the signal ADRLG, and outputs the biphase decode data BDAT.

While the CRC enable signal CENA2 is at the H level, the error of the biphase decoder data BDAT is detected by the second CRC circuit 109B.

Gray code decoder 108 is reset by the Gray code reset signal GSTR1, and while the Gray code enable signal CENA1 is at the H level, the biphase decode data BDAT is converted to the Gray code.

The CRC polarity signal CPOLE1 is set to the H level when the predetermined time has passed after the fall of the sync detection signal.

The sync window signal SYNCWIN2 is set to the H level when the predetermined time has passed after the fall of the sync detection signal SYNC 1. The sync detection signal SYNC2 is generated if the fixed pattern (01110001) is detected by sync pattern detector 105 while the sync window signal SYNCWIN2 is at the H level. When the sync detection signal SYNC2 rises, it is synchronized with the divided clock signal DCLK from divide-by-two frequency divider 104, and timing generator 106 sets the CRC enable signal CENA2 to the H level, the Gray code reset signal GSTR2 to the H level, and the Gray code enable signal GENA2 to the H level, respectively. In addition, when the predetermined time has passed after the rise of the sync detection signal SYNC2, the CRC polarity signal CPOLE2 is set to the H level by timing generator 106.

Furthermore, the output enable signal OUTENA is set to the H level by timing generator 106 when the predetermined time has passed after the rise of the sync detection signal SYNC1. In response to the output enable signal OUTENA, the address data ADRDAT is output as an address signal ADROUT by output control circuit 110.

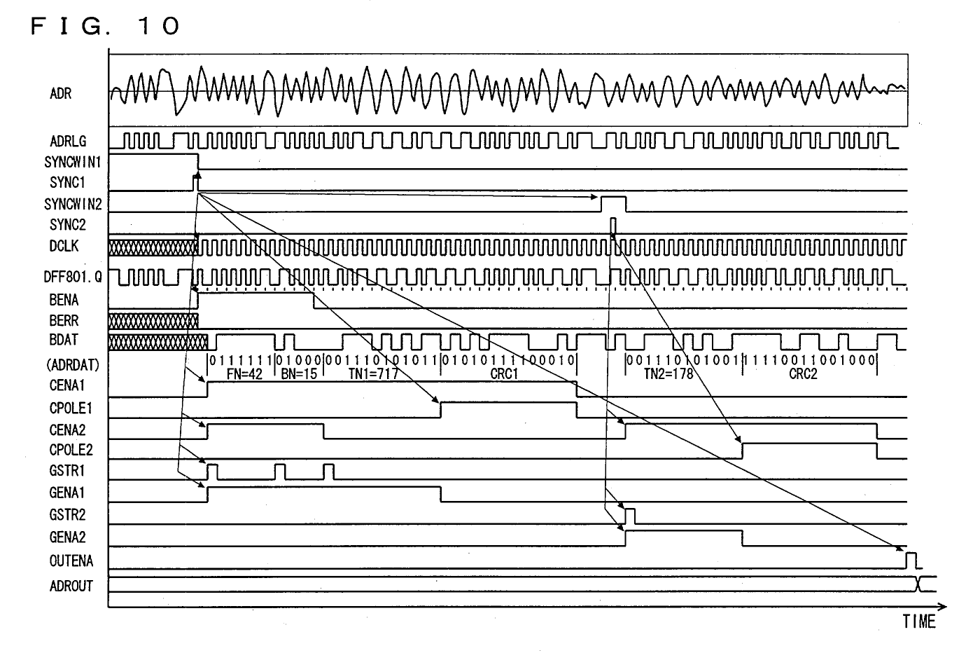

FIG. 10 is a timing chart showing the operation of the address decoder when the address signal is reproduced from the land. Herein, different from FIG. 9, the inverted signal of the wobble signal ADRT is selected by selector 102 in response to the land/groove signal LORG indicating the land, and the same is output as the signal ADRLG.

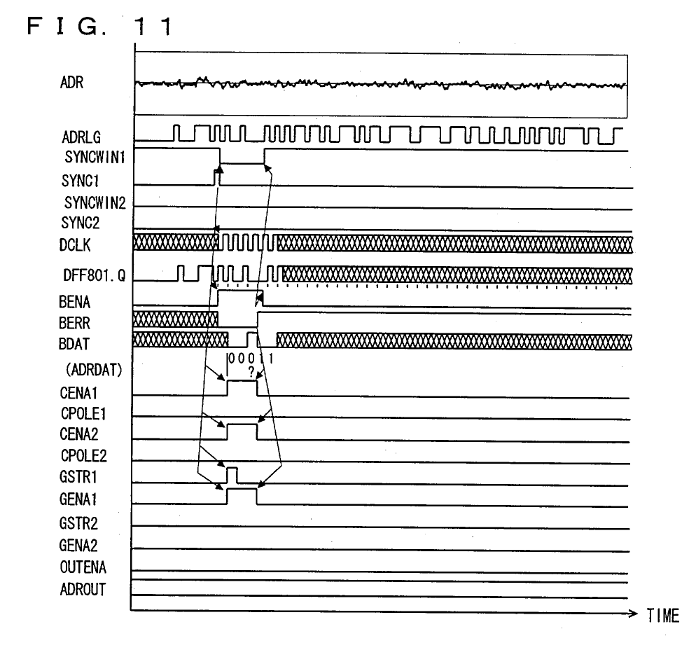

FIG. 11 is a timing chart showing the operation of the address decoder when the biphase error is detected. Different from FIGS. 9 and 10 wherein no error is detected, when the biphase error is detected by biphase decoder 107, the biphase error signal BERR is set to the H level. In response to this, timing generator 106 sets the sync window signal SYNCWIN1 to the H level, and the biphase enable signal BENA, the CRC enable signals CENA1 and CENA2, and the Gray code enable signal GENA1 are set to the L level.

As described above, according to this embodiment, the address can be reproduced with stability from the wobble shape in the AS-MO format with a small-scale circuit structure.

The embodiments disclosed herein are by way of illustration in all points and should not be taken by way of limitation. The scope of the present invention is indicated not by the above-mentioned description but by the appended claims, and it is intended to encompass all modifications falling within the equivalent spirit and scope of the appended claims.

Industrial Applicability

The present invention is applicable to an address decoder to reproduce an address signal by decoding a wobble signal picked up from a magneto-optical disk.

1. An address decoder to reproduce an address signal based on a wobble signal detected from an optical disk having a land and a groove and having an address preformatted therein by forming a wobble on the groove, comprising:
biphase decoding means decoding said wobble signal and outputting a biphase error signal indicating a presence or absence of a generation of a biphase error upon said decoding;
Gray code decoding means decoding a signal output from said biphase decoding means; and
an output control means controlling an output of a signal output from said Gray code decoding means as an address signal based on said biphase error signal

2. The address decoder according to claim 1, further comprising:
PLL means dividing an external clock signal and synchronizing it with said wobble signal to output a PLL clock signal;
frequency division means dividing said PLL clock signal to output a divided clock signal; and
timing generation means generating a biphase enable signal, a Gray code enable signal and an output enable signal; wherein
said biphase decoding means is activated in response to said divided clock signal and said biphase enable signal, and operates in synchronization with said PLL clock signal;
said Gray code decoding means is activated in response to said divided clock signal and said Gray code enable signal, and operates in synchronization with said PLL clock signal; and
said output control means is activated in response to said output enable signal.

3. The address decoder according to claim 1, wherein
at least two said addresses are continuously preformatted in said optical disk.

4. The address decoder according to claim 3, further comprising:
inverting means inverting said wobble signal; and
selecting means selecting one of said wobble signal and an inverted wobble signal inverted by said inverting means in response to a land/groove signal indicating whether the track being accessed at present is a land or a groove.

5. The address decoder according to claim 3, wherein:
a predetermined fixed pattern is performatted prior to said at least two addresses in said optical disk; and
said address decoder further comprising:
sync pattern detection means detecting said fixed pattern and outputting a sync detection signal; wherein
said frequency division means is reset in response to said sybnc detection signal.

6. The address decoder according to claim 1, further comprising:
error detection means detecting an error of a signal output from said biphase decoding means or said Gray code decoding means.
